(19) United States
(12) Patent Application Publication
(10) Pub. No.: US 2023/0118493 A1
(43) Pub. Date: Apr. 20, 2023

(54) OPPOSING ELECTRODE DETERMINATION METHOD, OPPOSING ELECTRODE DETERMINATION DEVICE, AND JIG USED IN SAME METHOD

(71) Applicant: MAZDA MOTOR CORPORATION, Hiroshima (JP)

(72) Inventors: Naotake ISHIZAKI, Hiroshima (JP); Kotaro KATAOKA, Hiroshima (JP); Keiko FUKUNAGA, Hiroshima (JP)

(73) Assignee: MAZDA MOTOR CORPORATION, Hiroshima (JP)

(21) Appl. No.: 17/905,845

(22) PCT Filed: Feb. 9, 2021
(86) PCT No.: PCT/JP2021/004797

§ 371 Date: Sep. 8, 2022

(30) Foreign Application Priority Data
Mar. 31, 2020 (JP) 2020-062836

(51) Int. Cl. B23K 11/11; B23K 11/31

(52) U.S. Cl. CPC B23K 11/115; B23K 11/314

(57) ABSTRACT

An opposing electrode determination method includes a step of inserting a pair of opposing electrodes into corresponding receiving portions, respectively, by holding, between the pair of opposing electrodes, a held member formed with the receiving portions on both sides; a step of measuring the inter-electrode distance between the pair of opposing electrodes; and a step of determining, based on the inter-electrode distance, whether a combination of the pair of opposing electrodes is correct or incorrect. The receiving portions are configured to have different insertion allowances for the opposing electrodes, respectively, according to the tip shape of each of the pair of opposing electrodes.

### TECHNICAL FIELD

The technology disclosed here relates to an opposing electrode determination method, an opposing electrode determination device, and a jig used in the opposing electrode determination method.

### BACKGROUND

Japanese Patent Application Laid-Open No. H4-65608 discloses capturing an image of a tip of an electrode rod as one example of a method for measuring the tip shape of the electrode rod. According to this method, the tip shape of the electrode rod can be measured by irradiating the tip of the electrode rod with a light beam emitted from a light source.

Additionally, Japanese Patent Application Laid-Open No. 2004-34105 discloses, as a method for measuring the distance between a pair of electrodes, a method for measuring the distance between the electrodes, based on a conversion coefficient obtained in advance, and an electrode position detected when welding a workpiece. Moreover, Japanese Patent Application Laid-Open No. 2004-34105 discloses determining whether any welding abnormality is present, and detecting the amount of wear of the electrodes, based on the measured distance between the electrodes.

### SUMMARY

A pair of opposing electrodes as disclosed in Japanese Patent Application Laid-Open No. H4-65608 and Japanese Patent Application Laid-Open No. 2004-34105 need to be replaced, according to the amount of wear. However, since there is a great variation in the tip shape of the opposing electrodes, it is necessary to determine whether the pair of electrodes are a correct combination, after the replacement, in order to perform desired welding.

Regarding a method for making such a determination, as disclosed in Japanese Patent Application Laid-Open No. H4-65608, for example, an image of the tip shape of each opposing electrode is captured. However, the method disclosed in Japanese Patent Application Laid-Open No. H4-65608 requires a camera, which is disadvantageous for reducing the cost. Furthermore, the method using a camera is not desirable in terms of reducing the cycle time.

In addition, it may be possible to use various sensors instead of a camera, but, like the case of using the camera, the use of sensors is disadvantageous for improving the production cost and the cycle time.

A technology disclosed here has been made in view of these points, to determine whether the combination of a pair of opposing electrodes is correct or incorrect, at lost cost and in a short time.

The technology disclosed here relates to an opposing electrode determination method for determining whether the combination of a pair of opposing electrodes is correct or incorrect. This opposing electrode determination method includes: a step of moving the pair of opposing electrodes toward a held member formed with receiving portions on both sides, and secured at a predetermined location, the receiving portions allowing insertion of the pair of opposing electrodes, respectively; a step of inserting the pair of opposing electrodes into the receiving portions, respectively, by holding the held member between the pair of opposing electrodes; a step of measuring an inter-electrode distance between the pair of opposing electrodes; and a step of determining, based on the inter-electrode distance, whether the combination is correct or incorrect.

Further, the receiving portions are configured to have different insertion allowances for the opposing electrodes, respectively, according to the tip shape of each of the pair of opposing electrodes.

Here, the term “insertion allowance” indicates an insertion limit of each opposing electrode when inserting the opposing electrode into the receiving portion. The receiving portions according to the present disclosure have different insertion allowances for the respective opposing electrodes, according to the tip shapes. Therefore, there is a difference in the amount of insertion into the receiving portion between when the opposing electrode having a predetermined tip shape is inserted into the receiving portion and when the opposing electrode having a different tip shape is inserted into the receiving portion.

Consequently, by holding the held member between the pair of opposing electrodes and inserting the pair of opposing electrodes into the respective receiving portions, an inter-electrode distance corresponding to the tip shapes of the respective opposing electrodes is realized. Therefore, it is possible to determine whether the combination of the pair of opposing electrodes is correct or incorrect by measuring the inter-electrode distance.

The above-described method does not require equipment such as a camera. Hence, according to the above-described method, it is possible to determine whether the combination of the pair of opposing electrodes is correct or incorrect, at low cost and within a short time.

Moreover, in certain embodiments the pair of opposing electrodes have mutually different vertical cross sections.

According to this method, the tip shape of one of the pair of opposing electrodes is different from the tip shape of the other. Consequently, for example, by using the receiving portions corresponding to the respective tip shapes of the correctly combined pair of opposing electrodes, it is possible to more reliably make a difference in the insertion allowance when the pair of opposing electrodes are incorrectly combined. This method is particularly effective for preventing the opposing electrodes having mutually different tip shapes from being mistaken for one another.

In addition, in certain embodiments each of the pair of opposing electrodes has a tip surface formed flat, and the area of the tip surface of one of the pair of opposing electrodes may be different from the area of the tip surface of the other.

According to this method, it is possible to more reliably make a difference in the insertion allowance when the pair of opposing electrodes are incorrectly combined. This method is particularly effective for preventing the opposing electrodes having mutually different tip shapes from being mistaken for one another.

Further, let one of the receiving portions, which is formed on one side of the held member, be a first receiving portion, and let the receiving portion formed on the other side of the held member be a second receiving portion, the first and second receiving portions may be made of recesses which are open toward mutually opposite directions, and a bottom of the recess constituting the first receiving portion and a bottom of the recess constituting the second receiving portion communicate via a through-hole.

According to this method, when, for example, an opposing electrode with a round tip is inserted into the first or second receiving portion, the tip of the opposing electrode can be inserted into the through-hole. In contrast, it is possible to configure such that when, for example, an opposing electrode with a flat tip is inserted into the first or second receiving portion, the tip of the opposing electrode cannot be inserted into the through-hole.

Thus, with the configuration that makes a difference as to whether the opposing electrodes can be inserted into the through-hole or not, according to the tip shapes of the opposing electrodes, it is possible to more reliably make a difference in the insertion allowances of the respective opposing electrodes.

Furthermore, in certain embodiments each of the pair of opposing electrodes is made of a rod-shaped electrode for spot welding.

The present disclosure is particularly effective when rod-shaped electrodes for spot welding are used as the pair of opposing electrodes.

Moreover, in certain embodiments the held member is restricted from moving along a holding direction of the pair of opposing electrodes.

Here, the term “holding direction” represents a moving direction of each of the opposing electrodes when the pair of opposing electrodes hold the held member therebetween. According to the method, by securing the pair of opposing electrodes in positions as described above, the inter-electrode distance can be more accurately measured.

The technology disclosed here also relates to an opposing electrode determination device for determining whether the combination of a pair of opposing electrodes is correct or incorrect. This opposing electrode determination device includes a held member formed with receiving portions on both sides and secured at a predetermined location, the receiving portions allowing insertion of the pair of opposing electrodes, respectively; and executes a step of inserting the pair of opposing electrodes into the receiving portions, respectively, by holding the held member between the pair of opposing electrodes, a step of measuring an inter-electrode distance between the pair of opposing electrodes, and a step of determining, based on the inter-electrode distance, whether the combination is correct or incorrect, wherein the receiving portions are configured to have different insertion allowances for the opposing electrodes, respectively, according to a tip shape of each of the pair of opposing electrodes.

According to this configuration, it is possible to determine whether the combination of the pair of opposing electrodes is correct or incorrect, at low cost and within a short time, without requiring equipment such as a camera.

The technology disclosed here also relates to a jig for determining whether the combination of a pair of opposing electrodes is correct or incorrect. This jig includes a held member formed with receiving portions on both sides, the receiving portions allowing insertion of the pair of opposing electrodes, respectively. The receiving portions are configured to have different insertion allowances for the opposing electrodes, respectively, according to the tip shape of each of the pair of opposing electrodes.

According to this configuration, it is possible to determine whether the combination of the pair of opposing electrodes is correct or incorrect, at low cost and within a short time, without requiring equipment such as a camera.

As described above, according to the present disclosure, it is possible to determine whether the combination of the pair of opposing electrodes is correct or incorrect, at low cost and within a short time.

### BRIEF DESCRIPTION OF THE DRAWINGS

FIG. 1 is a side view showing an example of a spot welding device including an opposing electrode determination device.

FIG. 2 is a side view showing an example of a welding gun.

FIG. 3 is a three-view drawing showing an example of a base member constituting a jig.

FIG. 4 is a two-view drawing showing an example of a held member constituting the jig.

FIG. 5A is a cross-sectional view for explaining the details of the held member.

FIG. 5B is a cross-sectional view for explaining the details of the held member.

FIGS. 6A-6D are views for explaining an insertion allowance of each opposing electrode.

FIG. 7 is a block diagram showing an example of a schematic configuration of a controller.

FIG. 8 is a flowchart showing a specific procedure of an opposing electrode determination method.

### DETAILED DESCRIPTION

Hereinafter, embodiments of the present disclosure will be described based on the drawings. Note that the following explanation describes examples.

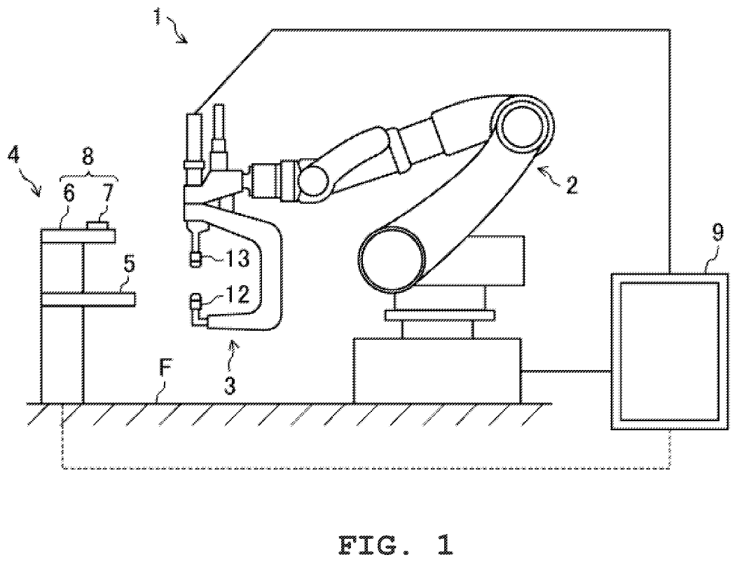

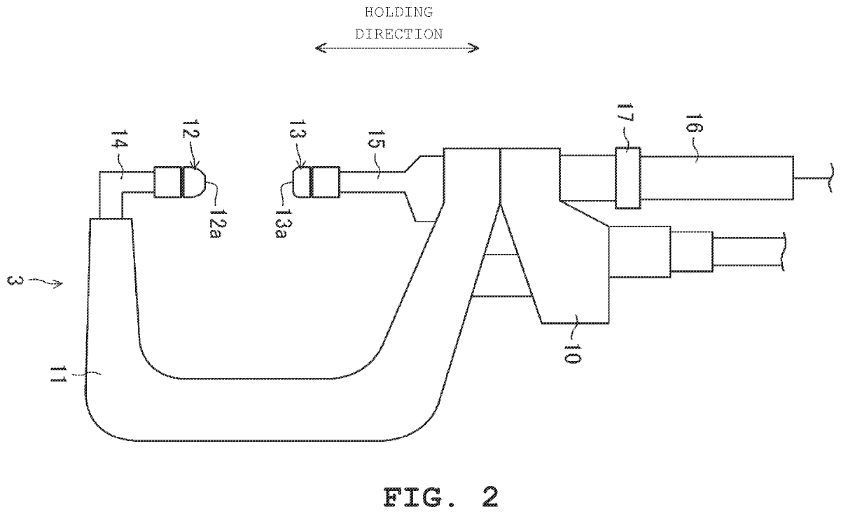

FIG. 1 is a side view showing an example of a spot welding device 1 including an opposing electrode determination device. Additionally, FIG. 2 is a side view showing an example of a welding gun 3.

As shown in FIG. 1, the spot welding device 1 includes; for example, a 6-axis robot 2; a welding gun 3 attached to a distal end of an arm of the robot 2; a dresser 5 for shaping and polishing a pair of opposing electrodes 12, 13 possessed by the welding gun 3; a frame member 4 having a jig 8 or the like for determining a combination of the pair of opposing electrodes 12, 13; and a controller 9 for controlling the robot 2, the welding gun 3, the dresser 5, etc. Among those, the jig 8 and the controller 9 constitute the opposing electrode determination device of the present embodiment.

-Robot 2-

The robot 2 is, for example, an articulated robot having six joint axes. The robot 2 is installed on a floor surface F. The robot 2 includes a servomotor (not shown) that drives each member around each joint axis. The servomotor is controlled by the controller 9.

-Welding Gun 3-

The welding gun 3 has: a base member 10 attached to the distal end of the arm of the robot 2; a substantially C-shaped arm 11 secured to the base member 10; the pair of opposing electrodes 12, 13 attached to the ends of the arm 11; a drive motor 16 for causing the other opposing electrode 13 to approach or separate from one opposing electrode 12; and an encoder 17 for detecting a rotation angle and a rotation amount of the drive motor 16. Each of the drive motor 16 and the encoder 17 is electrically connected to the controller 9.

More specifically, each of the pair of opposing electrodes 12, 13 is made of a rod-shaped electrode for spot welding. Of the pair of opposing electrodes 12, 13, the fixed electrode 12 located on the lower side is attached to an upper end of a rod 14 secured to the arm 11. This fixed electrode 12 is attached in a replaceable manner to the upper end of the rod 14.

Moreover, of the pair of opposing electrodes 12, 13, the movable electrode 13 located on the upper side is attached to a lower end of a rod 15 which is movable relative to the arm 11. The movable electrode 13 is disposed to face the fixed electrode 12. The movable electrode 13 is attached in a replaceable manner to the lower end of the rod 15.

The rod 15 to which the movable electrode 13 is attached moves up and down with the activation of the drive motor 16. When the rod 15 moves, the movable electrode 13 moves to approach or separate from the fixed electrode 12. At this time, the encoder 17 detects the rotation angle and the rotation amount of the drive motor 16, and then the controller 9 calculates the relative position of the movable electrode 13 to the fixed electrode 12, particularly the distance between the fixed electrode 12 and the movable electrode 13 in a holding direction (hereinafter, referred to as the “inter-electrode distance”). The controller 9 can execute various controls based on the results of calculation.

In addition, as shown in FIG. 2, the pair of opposing electrodes 12, 13 have mutually different vertical cross sections. Specifically, although the pair of opposing electrodes 12, 13 have tip surfaces 12a, 13a, respectively, each being formed flat, the pair of opposing electrodes 12, 13 have a difference in the area of the tip surfaces 12a, 13a.

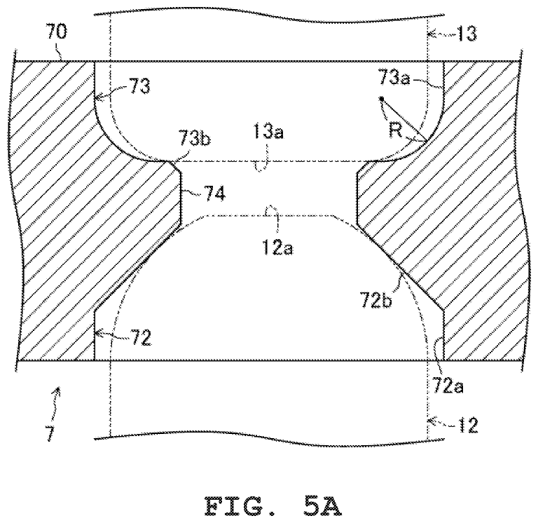

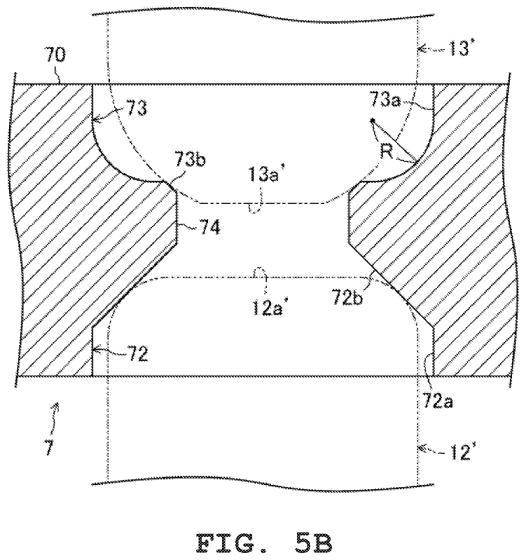

More specifically, the fixed electrode 12 located on the lower side has a semicircular vertical cross section with the tip cut flat (see FIGS. 5A, 5B). The tip surface 12a of the fixed electrode 12 extends flat along a plane perpendicular to the holding direction (up-down direction). Further, the fixed electrode 12 has a circular transverse cross section.

On the other hand, the movable electrode 13 located on the upper side has a rectangular vertical cross section with rounded corners (see FIGS. 5A, 5B). The tip surface 13a of the movable electrode 13 extends flat along a plane perpendicular to the holding direction (up-down direction). Moreover, like the fixed electrode 12, the movable electrode 13 has a circular transverse cross section.

Furthermore, as seen from later-described FIG. 5A and FIG. 5B, the area of the tip surface 12a of the fixed electrode 12 is smaller than the area of the tip surface 13a of the movable electrode 13.

Thus, for the fixed electrode 12 located on the lower side, normally, a semicircular electrode should be attached, but there is a possibility that a flat electrode like the movable electrode 13 located on the upper side may be attached as a result of erroneous electrode replacement. Hereinafter, the fixed electrode in the case of an erroneous electrode replacement is labeled as “12′,” and is called the “erroneously-attached fixed electrode” (see an alternate long and two short dashes line in FIG. 5B).

Similarly, for the movable electrode 13 located on the upper side, normally, a flat electrode should be attached, but there is a possibility that a semicircular electrode like the fixed electrode 12 located on the lower side may be attached as a result of erroneous electrode replacement. Hereinafter, the movable electrode in the case of an erroneous electrode replacement is labeled as “13′,” and is called the “erroneously-attached movable electrode” (see an alternate long and two short dashes line in FIG. 5B).

-Frame Member 4-

The frame member 4 is installed on the floor surface F. The dresser 5 for shaping and polishing the respective opposing electrodes 12, 13 is disposed at a substantially center of the frame member 4 in the up-down direction. Moreover, disposed at the top of the frame member 4 in the up-down direction is the jig 8 for determining, after replacing at least one of the pair of opposing electrodes 12, 13, whether the combination of the opposing electrodes 12, 13 after the replacement is correct or incorrect.

-Jig 8-

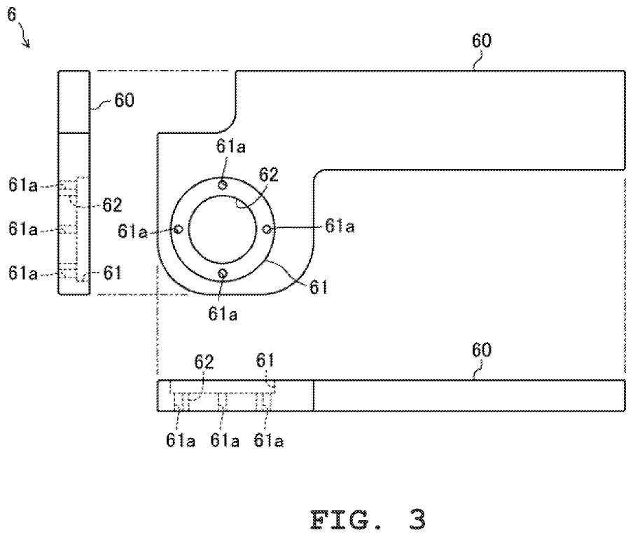

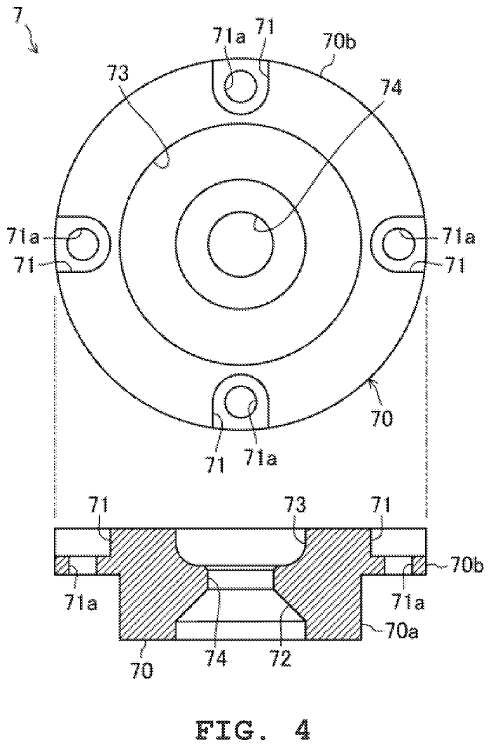

FIG. 3 is a three-view drawing showing an example of the base member 6 constituting the jig 8. Further, FIG. 4 is a two-view drawing showing an example of a held member 7 constituting the jig 8, and FIG. 5A and FIG. 5B are cross-sectional views for explaining the details of the held member 7.

As schematically shown in FIG. 1, the jig 8 according to the present embodiment includes the base member 6 supported on the frame member 4, and the held member 7 attached to the upper surface of the base member 6.

As shown in FIG. 3, the base member 6 is constituted by a substantially rectangular plate member 60. A recess 61 for attaching the held member 7 is formed on one side of the plate member 60 in a longitudinal direction. This recess 61 is open upward, and has a circular transverse cross section. An inner bottom surface of the recess 61 has a through-hole 62 with a smaller diameter than the opening of the recess 61. This through-hole 62 penetrates the base member 6 in a thickness direction (the up-down direction).

Moreover, the inner bottom surface of the recess 61 has four fastening holes 61a for fastening the held member 7 to the base member 6. The four fastening holes 61a are disposed to surround the through-hole 62. Fastening members such as bolts, not shown, can be inserted into the respective fastening holes 61a.

As shown in FIG. 4, the held member 7 is constituted by a substantially cylindrical disk member 70. This disk member 70 has a tubular portion 70a in the shape of a cylinder, and a collar portion 70b arranged along the outer circumference of the tubular portion 70a.

Among those, the tubular portion 70a is formed to have a diameter substantially the same as the through-hole 62 of the base member 6, and to be insertable into the through-hole 62. The collar portion 70b functions as a stopper when the tubular portion 70a is inserted into the through-hole 62.

The collar portion 70b is provided with four recesses 71 disposed at equal intervals along the circumferential direction. The recesses 71 are open upward. An inner diameter of each recess 71 is larger than an outer diameter of a head of the fastening member. Moreover, the inner bottom surface of each recess 71 has a fastening hole 71a for fastening the held member 7 to the base member 6.

When attaching the held member 7 to the base member 6, first, the tubular portion 70a of the held member 7 is inserted into the through-hole 62 of the base member 6. Subsequently, the tubular portion 70a is rotated around the center axis, and, in a state in which the fastening holes 61a of the base member 6 and the fastening holes 71a of the held member 7 are coaxially aligned, the fastening members are inserted for co-fastening.

Note that, in order to insert the fastening members, at least the recesses 71 of the held member 7 need to be disposed to face up. Consequently, the held member 7 can be attached to the base member 6 correctly, and not upside-down.

Furthermore, the held member 7 is formed with receiving portions 72, 73 on both sides, the receiving portions 72, 73 allowing insertion of the pair of opposing electrodes 12, 13, respectively. The receiving portions (72, 73) are configured to have different insertion allowances for the opposing electrodes (12, 13), respectively, according to the tip shapes of the pair of opposing electrodes (12, 13). Here, the term “insertion allowances” indicate the maximum values of insertable lengths (allowable insertion values) of the respective opposing electrodes 12, 13 when inserting the opposing electrodes 12, 13 into the respective receiving portions 72, 73.

Specifically, of the two receiving portions 72, 73, let the receiving portion 72 formed on one side (the lower side) of the held member 7 be the first receiving portion 72, and let the receiving portion 73 formed on the other side (the upper side) of the held member 7 be the second receiving portion 73, the first and second receiving portions 72, 73 are made of recesses which are open toward mutually opposite directions.

The recess constituting the first receiving portion 72 has a cross sectional shape corresponding to the fixed electrode 12 that is one of the pair of opposing electrodes 12, 13. Similarly, the recess constituting the second receiving portion 73 has a cross sectional shape corresponding to the movable electrode 13 that is the other of the pair of opposing electrodes 12, 13.

Specifically, the first receiving portion 72 is made of the recess which is open downward, and has a circular transverse cross section when a cross section perpendicular the up-down direction is seen. As shown in FIG. 5A, the first receiving portion 72 has a conical portion 72b tapered with the diameter increasing toward the lower side, and a cylindrical portion 72a formed coaxially with the conical portion 72b, and extending straight toward the lower side.

In the first receiving portion 72, a dimension of the conical portion 72b in the up-down direction is longer than a dimension of the cylindrical portion 72a in the up-down direction. Moreover, the inclination angle of the conical portion 72b is set between 30° and 60°, preferably between 40° and 50°.

Further, as shown in FIG. 5A and FIG. 5B, the inner diameter of the cylindrical portion 72a is larger than the outer diameter of the fixed electrode 12 and the erroneously-attached fixed electrode 12′. Therefore, as shown by the alternately long and two short dashes line in the respective drawings, the fixed electrode 12 or the erroneously-attached fixed electrode 12′ can be inserted into the cylindrical portion 72a, without causing interference between the members.

On the other hand, the second receiving portion 73 is made of the recess which is open upward, and, similarly to the first receiving portion 72, has a circular transverse cross section when a cross section perpendicular to the up-down direction is seen. As shown in FIG. 5A, the second receiving portion 73 has a conical portion 73b having a substantially tapered shape with the diameter increasing toward the upper side, and a cylindrical portion 73a formed coaxially with the conical portion 73b, and having rounded corners on the bottom side. The second receiving portion 73 is disposed coaxially with the first receiving portion 72.

In the second receiving portion 73, a dimension of the conical portion 73b in the up-down direction is shorter than a dimension of the cylindrical portion 73a in the up-down direction. Moreover, in the second receiving portion 73, a curvature radius R of the corners of the cylindrical portion 73a is smaller than a curvature radius of the fixed electrode 12 and the erroneously-attached movable electrode 13′, and is larger than a curvature radius of the movable electrode 13 and the erroneously-attached fixed electrode 12′ (see FIG. 5A and FIG. 5B).

Further, as shown in FIG. 5A and FIG. 5B, the inner diameter of the second receiving portion 73 is larger than the outer diameter of the movable electrode 13 and the erroneously-attached movable electrode 13′. Therefore, as shown by the alternately long and two short dashes line in the respective drawings, the movable electrode 13 or the erroneously-attached movable electrode 13′ can be inserted into the second receiving portion 73, without causing interference between the members.

Furthermore, the bottom of the recess constituting the first receiving portion 72 (specifically, the bottom of the conical portion 72b) and the bottom of the recess constituting the second receiving portion (specifically, the bottom of the conical portion 73b) communicate via a through-hole 74.

The through-hole 74 has a substantially circular transverse cross section. As shown in FIG. 5A, the inner diameter of the through-hole 74 is larger than the outer diameter of the tip surface 12a of the fixed electrode 12, and is smaller than the outer diameter of the tip surface 13a of the movable electrode 13. Similarly, as shown in FIG. 5B, the inner diameter of the through-hole 74 is smaller than the outer diameter of the tip surface 12a′ of the erroneously-attached fixed electrode 12′, and is larger than the outer diameter of the tip surface 13a of the erroneously-attached movable electrode 13′.

Therefore, as shown in FIG. 5A and FIG. 5B, when the held member 7 is held between the pair of opposing electrodes 12, 13, the tip surface 12a of the fixed electrode 12 enters into the through-hole 74, while the tip surface 13a of the movable electrode 13 is restricted from entering into the through-hole 74. Similarly, the tip surface 13a′ of the erroneously-attached movable electrode 13′ is allowed to enter into the through-hole 74, whereas the tip surface 12a′ of the erroneously-attached fixed electrode 12′ is restricted from entering into the through-hole 74. Thus, by setting whether or not to allow the entry into the through-hole 74, according to the tip shapes of the respective electrodes 12, 13, it is possible to vary the insertion allowance according to each tip shape.

The held member 7 configured as described above is fixed to a predetermined position (an upper end) of the frame member 4 through the base member 6. Since the frame member 4 is installed on the floor surface F, the movement of the held member 7 relative to the floor surface F, that is, the movement of the held member 7 in the holding direction (up-down direction) is restricted.

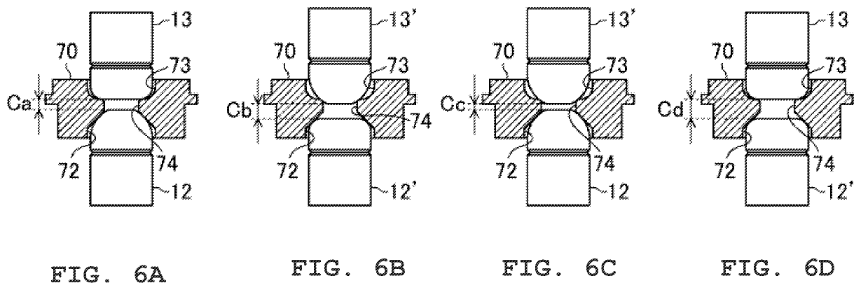

FIGS. 6A-6D are views for explaining the insertion allowance of each opposing electrode.

FIG. 6A shows an inter-electrode distance Ca when both of the pair of opposing electrodes 12, 13 are correctly replaced. FIG. 6B shows an inter-electrode distance Cb when the erroneously-attached fixed electrode 12′ and the erroneously-attached movable electrode 13′ are mistaken for the fixed electrode 12 and the movable electrode 13 of the pair of opposing electrodes 12, 13, respectively. FIG. 6C shows an inter-electrode distance Cc when the erroneously-attached movable electrode 13′ is mistaken for the movable electrode 13 of the pair of opposing electrodes 12, 13. FIG. 6D shows an inter-electrode distance Cd when the erroneously-attached fixed electrode 12′ is mistaken for the fixed electrode 12 of the pair of opposing electrodes 12, 13.

As can be seen from a comparison between FIG. 6A and FIG. 6D, when the erroneously-attached fixed electrode 12′ is mistaken for the fixed electrode 12, unlike the movable electrode 13, the erroneously-attached fixed electrode 12′ is not inserted into the through-hole 74. Since the erroneously-attached fixed electrode 12′ is not inserted, the erroneously-attached fixed electrode 12′ is separated from the movable electrode 13.

Therefore, the inter-electrode distance Cd between the erroneously-attached fixed electrode 12′ and the movable electrode 13 is longer than the inter-electrode distance Ca between the fixed electrode 12 and the movable electrodes 13 (Ca<Cd).

As can be seen from a comparison between FIG. 6A and FIG. 6C, when the erroneously-attached movable electrode 13′ is mistaken for the movable electrode 13, unlike the fixed electrode 12, the erroneously-attached fixed electrode 13′ is inserted into the through-hole 74. Since the erroneously-attached movable electrode 13′ is inserted, the erroneously-attached movable electrode 13′ approaches the fixed electrode 12.

Therefore, the inter-electrode distance Cc between the fixed electrode 12 and the erroneously-attached movable electrode 13′ is shorter than the inter-electrode distance Ca between the fixed electrode 12 and the movable electrodes 13 (Cc<Ca).

As can be seen from a comparison between FIG. 6A and FIG. 6B, when the erroneously-attached fixed electrode 12′ and the erroneously-attached movable electrode 13′ are mistaken for the fixed electrode 12 and the movable electrode 13 of the pair of opposing electrodes 12, 13, respectively, the influence on the inter-electrode distance caused by mistaking the erroneously-attached fixed electrode 12′ for the fixed electrode 12 has a bigger effect compared to the influence on the inter-electrode distance caused by mistaking the erroneously-attached movable electrode 13′ for the movable electrode 13.

Therefore, the inter-electrode distance Cb between the erroneously-attached fixed electrode 12′ and the erroneously-attached movable electrode 13′ is longer compared to the inter-electrode distance Ca between the fixed electrode 12 and the movable electrodes 13 (Ca<Cb).

Note that, the inter-electrode distance Cb in the case of (B) is shorter than the inter-electrode distance Cd in the case of (D) because the erroneously-attached movable electrode 13′ enters into the through-hole 74.

From the above, the following expression is obtained for the relation in magnitude among the inter-electrode distances according to four combinations.

Cc<Ca<Cb<Cd

Thus, the insertion allowances when inserting into the receiving portions 72, 73 are varied according to the tip shapes of the respective fixed electrode 12, the movable electrode 13, the erroneously-attached fixed electrode 12′, and the erroneously-attached movable electrode 13′, and simultaneously the inter-electrode distance can be varied among the four combinations.

-Controller 9-

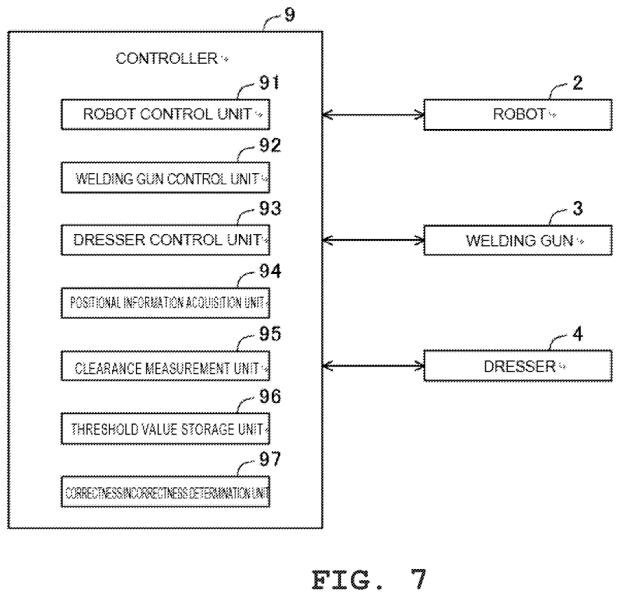

FIG. 7 is a block diagram showing an example of a schematic configuration of the controller 9. The controller 9 is constituted by a CPU, a memory, and a bus. The controller 9 includes, as elements for controlling the respective parts of the spot welding device 1, a robot control unit 91 for controlling the robot 2, a welding gun control unit 92 for controlling the welding gun 3, and a dresser control unit 93 for controlling the dresser 5.

The controller 9 executes spot welding with the pair of opposing electrodes 12, 13 by controlling the spot welding device 1 through the robot control unit 91, the welding gun control unit 92 and the dresser control unit 93.

Among those, the robot control unit 91 can operate the arm of the robot 2, and move the welding gun 3 to a desired position. Moreover, the welding gun control unit 92 can operate the drive motor 16, detect an operating current value of the drive motor 16, and calculate the moved position of the movable electrode 13 upon receipt of a signal from the encoder 17.

The controller 9 also includes, as elements constituting the opposing electrode determination device: a positional information acquisition unit 94 for acquiring positional information on the respective opposing electrodes 12, 13; a clearance measurement unit 95 for measuring the inter-electrode distance; a threshold value storage unit 96 for storing a threshold value as a criterion for the inter-electrode distance; and a correctness/incorrectness determination unit 97 for executing a determination based on the measured value of the inter-electrode distance and the threshold value.

Among those, the positional information acquisition unit 94 causes, through the robot control unit 91, the pair of opposing electrodes 12, 13 to move to the dresser 5, and causes, through the welding gun control unit 92, both the electrodes 12, 13 to be pressed against the dresser 5 (particularly, a dressing edge of the dresser) at a predetermined pressure. The positional information acquisition unit 94 acquires, through the welding gun control unit 92, the moved position of the movable electrode 13 at the time of pressing.

The positional information acquisition unit 94 sets the acquired moved position as a standard position to be a standard for the inter-electrode distance. A determination using the jig 8 can be made based on a displacement amount from the standard position. That is to say, this standard position is equivalent to the zero point of the inter-electrode distance.

The clearance measurement unit 95 causes, through the robot control unit 91, the pair of opposing electrodes 12, 13 to move toward the jig 8 (particularly, the held member 7). Moreover, the clearance measurement unit 95 causes, through the welding gun control unit 92, the held member 7 is held between the pair of opposing electrodes 12, 13, and the pair of opposing electrodes 12, 13 to be inserted into the corresponding receiving portions 72, 73, respectively.

After the insertion into the receiving portions 72, 73, the clearance measurement unit 95 calculates the moved position of the movable electrode 13 through the welding gun control unit 92, and calculates the difference between the moved position and the standard position set by the positional information acquisition unit 94. The calculated difference is the above-mentioned inter-electrode distance. Thus, the clearance measurement unit 95 measures the inter-electrode distance between the pair of opposing electrodes 12, 13.

The threshold value storage unit 96 stores an allowable range of the inter-electrode distance for determining whether the combination of the pair of opposing electrodes 12, 13 is correct or incorrect. This allowable range includes an upper limit and a lower limit as criteria for the inter-electrode distance, and is preset according to the tip shapes of the electrodes 12, 13 when the pair of opposing electrodes 12, 13 are determined to be a correct combination.

Specifically, the allowable range is set as a numerical range of the inter-electrode distance such that the inter-electrode distance is out of the allowable range when the erroneously-attached fixed electrode 12′ is erroneously attached for the fixed electrode 12 of the pair of opposing electrodes 12, 13, when the erroneously-attached movable electrode 13′ is erroneously attached for the movable electrode 13, and when both the fixed electrode 12 and the movable electrode 13 are erroneously attached, and is within the range in other case (when the combination of the fixed electrode 12 and the movable electrode 13 is correct).

The correctness/incorrectness determination unit 97 determines, based on the inter-electrode distance measured by the clearance measurement unit 95, whether the combination of the pair of opposing electrodes 12, 13 is correct or incorrect. Specifically, the correctness/incorrectness determination unit 97 reads the inter-electrode distance calculated by the clearance measurement unit 95, and the allowable range stored in the threshold value storage unit 96.

Then, the correctness/incorrectness determination unit 97 determines whether the inter-electrode distance is within the allowable range. If the inter-electrode distance is within the allowable range, the correctness/incorrectness determination unit 97 determines that the combination of the opposing electrodes 12, 13 is correct. Whereas if the inter-electrode distance is not within the allowable range, the correctness/incorrectness determination unit 97 determines that the combination of the opposing electrodes 12, 13 is incorrect. In the latter case, the correctness/incorrectness determination unit 97 notifies, via a display or the like, a user that the combination of the opposing electrodes 12, 13 is incorrect.

Specific Example of Opposing Electrode Determination Method

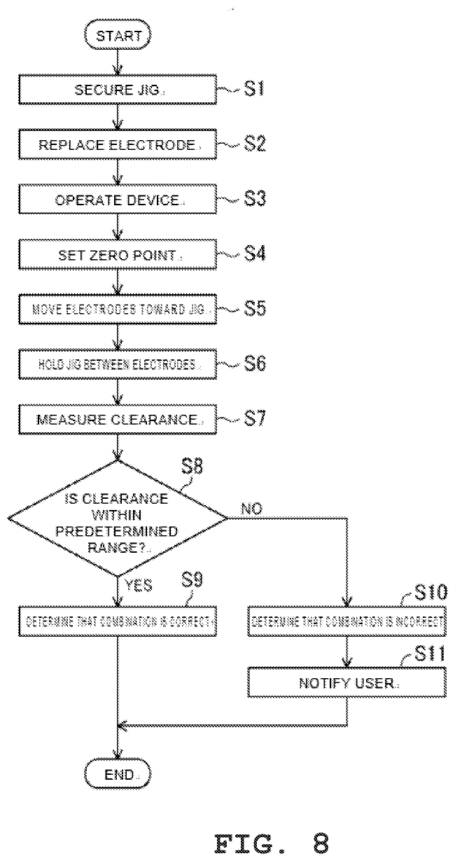

FIG. 8 is a flowchart showing a specific procedure of an opposing electrode determination method. Hereinafter, an example of the specific procedure of the opposing electrode determination method will be described. This method is executed by the jig 8 and the controller 9 as the opposing electrode determination device.

First, step S1 is a step to be executed at a preparation stage before activating the spot welding device 1. Step 1 is a step omitted in a normal operation after securing the jig 8.

Specifically, in step S1, the user installs the frame member 4 on the floor surface F around the robot 2, and also secures the jig 8 to the frame member 4. Regarding the way of securing the jig 8, it is preferred to install the jig 8 to be at least immovable along a direction in which the pair of opposing electrodes 12, 13 approach or separate from each other.

Suppose that, in subsequent step S2, the user replaces at least one of the pair of opposing electrodes 12, 13. Then, suppose that, in step S3 following step S2, the user operates the spot welding device 1.

In subsequent step S4, the positional information acquisition unit 94 causes, through the robot control unit 91 and the welding gun control unit 92, the replaced opposing electrodes 12, 13 to be pressed against the dresser 5. The positional information acquisition unit 94 sets, based on the moved position of the movable electrode 13 at the time of pressing, the zero point of the inter-electrode distance (clearance).

In subsequent step S5, the clearance measurement unit 95 controls the robot 2 through the robot control unit 91 to move the replaced pair of opposing electrodes 12, 13 toward the held member 7 secured to the frame member 4 as a predetermined location.

In subsequent step S6, the clearance measurement unit 95 controls the welding gun 3 through the welding gun control unit 92 to hold the held member 7 between the pair of opposing electrodes 12, 13. At this time, the clearance measurement unit 95 inserts the pair of opposing electrodes 12, 13 into the corresponding receiving portions 72, 73, respectively.

Specifically, the clearance measurement unit 95 moves the movable electrode 13 to approach the fixed electrode 12. The clearance measurement unit 95 uses the approaching movement to insert the fixed electrode 12 into the first receiving portion 72, and insert the movable electrode 13 into the second receiving portion 73.

In subsequent step S7, the clearance measurement unit 95 measures the inter-electrode distance (clearance), based on the moved position of the movable electrode moved in step S6 and the zero point set in step S4.

In subsequent step S8, the correctness/incorrectness determination unit 97 determines, based on the inter-electrode distance measured in step S7, whether the combination of the electrodes 12, 13 after replacing at least one of the pair of opposing electrodes 12, 13 is correct or incorrect.

Specifically, in step S8, the correctness/incorrectness determination unit 97 determines whether the inter-electrode distance measured in step S7 is within the allowable range stored in the threshold value storage unit 96. More specifically, the correctness/incorrectness determination unit 97 determines whether the inter-electrode distance is not less than the lower limit defining the allowable range, and not more than the upper limit defining the allowable range.

If the determination in step S8 is YES, the control process proceeds to step S9 from S8. On the other hand, if the determination is NO, the control process proceeds to step S10 from S8.

In step S9, the correctness/incorrectness determination unit 97 determines that the combination of the opposing electrodes 12, 13 is correct. In this case, the control process is finished.

On the other hand, in step S10, the correctness/incorrectness determination unit 97 determines that the combination of the opposing electrodes 12, 13 is incorrect. In this case, it is determined whether the erroneously-attached fixed electrode 12′ is attached instead of the fixed electrode 12 of the pair of opposing electrodes 12, 13, whether the erroneously-attached movable electrode 13′ is attached instead of the movable electrode 13, and whether both the electrodes 12, 13 are erroneously attached. In this case, the control process proceeds to step S11 from step S10.

In step S11, the controller 9 notifies the user, via the display or the like, that at least one of the pair of opposing electrodes 12, 13 is erroneously attached. After the notification to the user, the control process is finished.

Regarding Correctness/Incorrectness Determination for Opposing Electrodes

As described above, by holding the held member 7 between the pair of opposing electrodes 12, 13 and inserting the pair of opposing electrodes 12, 13 into the respective receiving portions 72, 73, the inter-electrode distance corresponding to the tip shapes of the respective opposing electrodes 12, 13 is realized. Therefore, as shown by way of example in steps S7 to S8 of FIG. 8, it is possible to determine whether the combination of the pair of opposing electrodes 12, 13 is correct or incorrect by measuring the inter-electrode distance.

The method according to the present embodiment does not require equipment such as a camera. Therefore, according to the present embodiment, it is possible to determine whether the combination of the pair of opposing electrodes 12, 13 is correct or incorrect, at low cost and within a short time.

Moreover, as shown by way of example in FIG. 2, the tip shape of one of the pair of opposing electrodes 12, 13 is different from the tip shape of the other. Therefore, as shown by way of example in FIG. 5A and FIGS. 6A-6D, by using the receiving portions 72, 73 corresponding to the respective shapes of the correctly combined pair of opposing electrodes 12, 13, it is possible to more reliably make a difference in the insertion allowances when the pair of opposing electrodes 12, 13 are incorrectly combined. This method is particularly effective for preventing the opposing electrodes 12, 13 having mutually different tip shapes from being mistaken for one another.

Further, since the area of the tip surface 12a of the fixed electrode 12 is different from the area of the tip surface 13a of the movable electrode 13, it is possible to more reliably make a difference in the insertion allowances when the pair of opposing electrodes 12, 13 are incorrectly combined. This method is particularly effective for preventing the opposing electrodes 12, 13 having mutually different tip shapes from being mistaken for one another.

Furthermore, as shown by way of example in FIG. 5A, when, for example, the fixed electrode 12 tapering toward the tip is inserted into the first receiving portion 72, the tip surface 12a of the fixed electrode 12 can be inserted into the through-hole 74. In contrast, it is possible to configure such that, when the movable electrode 13 with a flat tip is inserted into the second receiving portion 73, the tip surface 13a of the movable electrode 13 cannot be inserted into the through-hole 74. This is the same when the erroneously-attached fixed electrode 12′ is attached instead of the fixed electrode 12, or when the erroneously-attached movable electrode 13′ is attached instead of the movable electrode 13.

Thus, with the configuration that makes a difference as to whether the opposing electrodes 12, 13 can be inserted into the through-hole 74 or not, according to the tip shapes of the opposing electrodes 12, 13, it is possible to more reliably make a difference in the insertion allowances of the respective opposing electrodes 12, 13.

### OTHER EMBODIMENTS

In the above embodiment, although the elements of the electrode determination device, such as the robot control unit 91 for controlling the robot 2, the welding gun control unit 92 for controlling the welding gun 3, and the positional information acquisition unit 94, are integrally implemented on the controller 9, the present disclosure is not limited to such a configuration. The robot control unit 91 and the welding gun control unit 92 may be controlled by separate control units, or the elements of the electrode determination device may be implemented on a separate computer.

Although the receiving portions 72, 73 of the above embodiment have the cross sectional shapes corresponding to the pair of the opposing electrodes 12, 13, respectively, the configuration of the receiving portions is not limited to this. For example, the first receiving portion 72 and the second receiving portion 73 may be configured to have the same cross sectional shape. In this case, the magnitude of the allowable range is more precisely set.

Furthermore, although the pair of opposing electrodes 12, 13 according to the above embodiment are configured as rod-shaped electrodes for spot welding, the present disclosure is not limited to such a configuration. The opposing electrodes according to the present disclosure may be constituted by, for example, roller electrodes.

What is claimed is:

1. An opposing electrode determination method for determining whether a combination of a pair of opposing electrodes is correct or incorrect, the opposing electrode determination method comprising:
a step of moving the pair of opposing electrodes toward a held member formed with receiving portions on both sides and secured at a predetermined location, the receiving portions allowing insertion of the pair of opposing electrodes, respectively;
a step of inserting the pair of opposing electrodes into the receiving portions, respectively, by holding the held member between the pair of opposing electrodes;
a step of measuring an inter-electrode distance between the pair of opposing electrodes; and
a step of determining, based on the inter-electrode distance, whether the combination is correct or incorrect, wherein
the receiving portions are configured to have different insertion allowances for the opposing electrodes, respectively, according to a tip shape of each of the pair of opposing electrodes.

2. The opposing electrode determination method according to claim 1, wherein the pair of opposing electrodes have mutually different vertical cross sections.

3. The opposing electrode determination method according to claim 2, wherein
each of the pair of opposing electrodes has a tip surface formed flat, and
an area of the tip surface of one of the pair of opposing electrodes is different from an area of the tip surface of the other.

4. The opposing electrode determination method according to claim 1, wherein,
one of the receiving portions, which is formed on one side of the held member, is a first receiving portion, and the receiving portion formed on the other side of the held member is a second receiving portion, and the first and second receiving portions comprise recesses which are open toward mutually opposite directions, and
a bottom of the recess constituting the first receiving portion and a bottom of the recess constituting the second receiving portion communicate via a through-hole.

5. The opposing electrode determination method according to claim 1, wherein each of the pair of opposing electrodes comprises a rod-shaped electrode for spot welding.

6. The opposing electrode determination method according to claim 1, wherein the held member is restricted from moving along a holding direction of the pair of opposing electrodes.

7. An opposing electrode determination device for determining whether a combination of a pair of opposing electrodes is correct or incorrect, the opposing electrode determination device comprising
a held member with receiving portions on both sides, and secured at a predetermined location, the receiving portions allowing insertion of the pair of opposing electrodes, respectively, by executing:
a step of inserting the pair of opposing electrodes into the receiving portions, respectively, by holding the held member between the pair of opposing electrodes;
a step of measuring an inter-electrode distance between the pair of opposing electrodes; and
a step of determining, based on the inter-electrode distance, whether the combination is correct or incorrect, wherein
the receiving portions are configured to have different insertion allowances for the opposing electrodes, respectively, according to a tip shape of each of the pair of opposing electrodes.

8. The opposing electrode determination device according to claim 7, wherein,
one of the receiving portions, which is formed on one side of the held member, is a first receiving portion, and the receiving portion formed on the other side of the held member is a second receiving portion, and the first and second receiving portions comprise recesses which are open toward mutually opposite directions, and
a bottom of the recess constituting the first receiving portion and a bottom of the recess constituting the second receiving portion communicate via a through-hole.

9. The opposing electrode determination device according to claim 7, wherein each of the pair of opposing electrodes comprises a rod-shaped electrode for spot welding.

10. The opposing electrode determination device according to claim 7, wherein the held member is restricted from moving along a holding direction of the pair of opposing electrodes.

11. A jig for use in determining whether a combination of a pair of opposing electrodes is correct or incorrect, the jig comprising
a held member formed with receiving portions on both sides, the receiving portions allowing insertion of the pair of opposing electrodes, respectively, wherein
the receiving portions are configured to have different insertion allowances for the opposing electrodes, respectively, according to a tip shape of each of the pair of opposing electrodes.

12. The jig according to claim 11, wherein,
one of the receiving portions, which is formed on one side of the held member, is a first receiving portion, and the receiving portion formed on the other side of the held member is a second receiving portion, and the first and second receiving portions comprise recesses which are open toward mutually opposite directions, and
a bottom of the recess constituting the first receiving portion and a bottom of the recess constituting the second receiving portion communicate via a through-hole.

13. The opposing electrode determination method according to claim 2, wherein
one of the receiving portions, which is formed on one side of the held member, is a first receiving portion, and the receiving portion formed on the other side of the held member is a second receiving portion, and the first and second receiving portions comprise recesses which are open toward mutually opposite directions, and
a bottom of the recess constituting the first receiving portion and a bottom of the recess constituting the second receiving portion communicate via a through-hole.

14. The opposing electrode determination method according to claim 3, wherein
one of the receiving portions, which is formed on one side of the held member, is a first receiving portion, and the receiving portion formed on the other side of the held member is a second receiving portion, and the first and second receiving portions comprise recesses which are open toward mutually opposite directions, and
a bottom of the recess constituting the first receiving portion and a bottom of the recess constituting the second receiving portion communicate via a through-hole.

15. The opposing electrode determination method according to claim 14, wherein each of the pair of opposing electrodes comprises a rod-shaped electrode for spot welding.

16. The opposing electrode determination method according to claim 15, wherein the held member is restricted from moving along a holding direction of the pair of opposing electrodes.

17. The opposing electrode determination method according to claim 4, wherein each of the pair of opposing electrodes comprises a rod-shaped electrode for spot welding.

18. The opposing electrode determination method according to claim 17, wherein the held member is restricted from moving along a holding direction of the pair of opposing electrodes.

19. The opposing electrode determination device according to claim 8, wherein each of the pair of opposing electrodes comprises a rod-shaped electrode for spot welding.

20. The opposing electrode determination device according to claim 19, wherein the held member is restricted from moving along a holding direction of the pair of opposing electrodes.
